(19) United States
(12) Patent Application Publication
(10) Pub. No.: US 2026/0097704 A1
(43) Pub. Date: Apr. 9, 2026

(54) TRIM ELEMENT WITH BACKLIT LOGO AND RADAR

(71) Applicant: Flex-N-Gate France, AUDINCOURT (FR)

(72) Inventors: Olivier PUJOL, BELFORT (FR); Stéphanie BERGERAT, AUDINCOURT (FR)

(21) Appl. No.: 19/347,273

(22) Filed: Oct. 1, 2025

(30) Foreign Application Priority Data
Oct. 7, 2024 (FR) 24 10803

(51) Int. Cl. B60Q 1/00; B60R 13/04; G01S 7/02; G01S 13/931

(52) U.S. Cl. CPC B60Q 1/0023; B60R 13/04; G01S 7/028; G01S 13/931; B60R 2300/806; G01S 2013/93275

(57) ABSTRACT

The present invention relates to a vehicle trim element (10) comprising:
a casing (12) extending in a thickness direction between a support element (14) and a decorative element (20),
a radar (30) emitting electromagnetic radiation in the thickness direction, said radar (30) being positioned outside the casing (12), the electromagnetic radiation traversing said casing in an emission zone,
a light source (32) extending in the casing, said light source (32) emitting visible light radiation,
characterized in that the light source (32) extends around the emission zone and illuminates the decorative element (20), a part of the light radiation being reflected in the casing (12) so as to direct said part of the radiation in the thickness direction in the emission zone.

The present invention relates to a vehicle trim element comprising:
a casing extending in a thickness direction between a support element and a decorative element,
a radar emitting electromagnetic radiation in the thickness direction, said radar being positioned outside the casing on the side of the support element, the electromagnetic radiation traversing said casing from the support element to the decorative element in an emission zone,
a light source extending in the casing between the support element and the decorative element, said light source emitting visible light radiation.

The invention relates, for example, to a trim element comprising a backlit pattern inserted into a vehicle body element, for example, like an emblem.

Backlit trim elements are known, with the backlighting arranged, for example, to highlight a symbol, such as the logo of the manufacturer or another distinctive element. Such trim elements comprise, for example, a casing receiving the light source allowing the backlighting.

It is also known in the prior art to provide a vehicle with one or more radars, for example, to detect obstacles around the vehicle and assist with its driving. Such a radar is, for example, positioned near the internal surface of an external vehicle trim element to emit electromagnetic radiation towards the outside of the vehicle while being invisible from the outside of the vehicle.

However, integrating such a radar with a backlit trim element is complicated, particularly due to the space taken up by the presence of the radar and the light source allowing the backlighting and due to the disturbance that the presence, in the path of the wave emitted by the radar, of parts opaque to electromagnetic radiation or parts whose geometry can modify this path, is likely to cause. Such disturbance is likely to degrade the operation of the radar and impair its detection capabilities.

One of the aims of the invention is to propose a backlit trim element equipped with a compact radar that functions satisfactorily.

To this end, the invention relates to a vehicle trim element comprising:
a casing extending in a thickness direction between a support element and a decorative element,
a radar emitting electromagnetic radiation in the thickness direction, said radar being positioned outside the casing on the side of the support element, the electromagnetic radiation traversing said casing from the support element to the decorative element in an emission zone,
a light source extending in the casing between the support element and the decorative element, said light source emitting visible light radiation,
characterized in that the light source extends around at least part of the emission zone and illuminates the decorative element in the thickness direction, at least part of the light radiation being reflected in the casing by the support element so as to direct said part of the radiation in the thickness direction in the emission zone.

The use of the support element as a light reflection surface allows for the creation of a backlit trim element by moving the light source out of the emission zone of the radar so that the electromagnetic radiation emitted by the radar is not disturbed by the lighting system components. Thus, the radar can be placed immediately behind the casing, making the trim element more compact.

The trim element according to the invention may also comprise one or more of the following features, taken individually or in any technically feasible combination:
The support element extends in the thickness direction of the casing, between an external face and an internal face, facing the inside of the casing, the radar extending opposite the external face and emitting electromagnetic radiation traversing the support element from the external face to the internal face, the support element being transparent to the electromagnetic radiation emitted by the radar, at least part of the internal face reflecting visible light so that the light emitted by the light source is reflected by said part of the internal face in the thickness direction towards the decorative element.
The decorative element extends in the thickness direction of the casing between an internal face facing the inside of the casing and an external face, the decorative element being transparent to electromagnetic radiation from the internal face to the external face and diffusing visible light.
A mask is applied to the internal face or the external face of the decorative element, said mask defining a pattern comprising at least one opaque zone and a zone allowing light to pass through.
At least part of the pattern extends opposite the emission zone so as to be traversed by the electromagnetic radiation.
The light source comprises at least one light source injecting light into the light guide, the light guide extending between the support element and the decorative element around at least part of the emission zone in a radial plane perpendicular to the thickness direction of the casing.
The light source comprises two light guides extending on either side of the emission zone in the radial plane.
The two light guides each extend between two ends, each end of a light guide being connected to the corresponding end of the other light guide by a connecting element carrying a light source and extending outside the emission zone.
The emission zone is entirely included in the space located between the two light guides in the radial plane.
The casing (12) is sealed between the support element (14) and the decorative element (20).

The invention will become clearer upon reading the following description, given solely by way of non-limiting example, and made with reference to the drawings wherein:

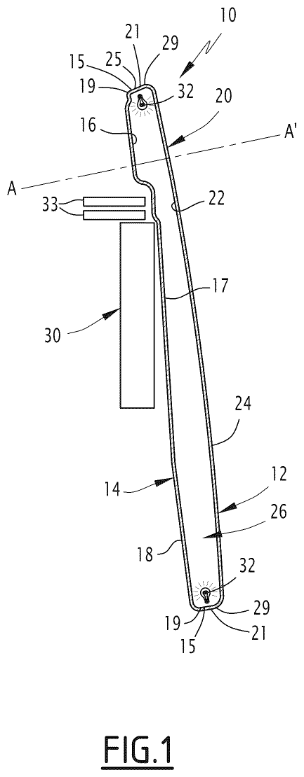

FIG. 1 is a first schematic sectional representation of a trim element according to the invention,

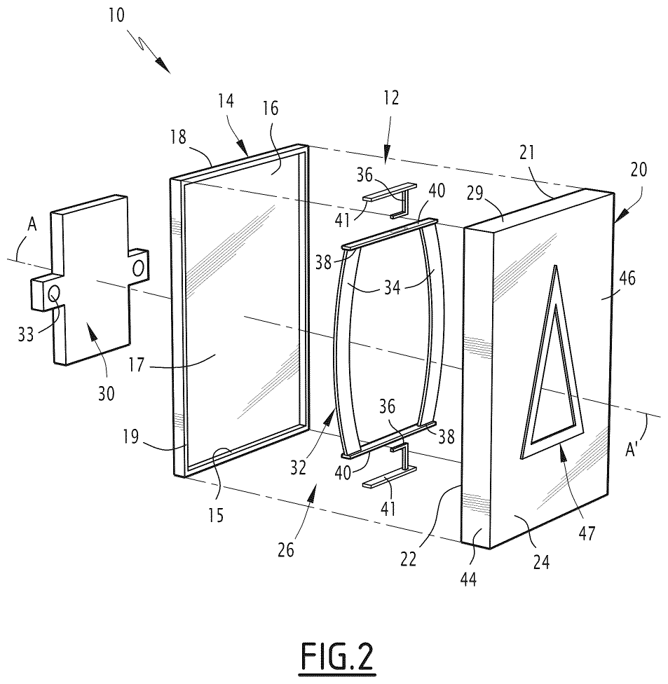

FIG. 2 is an exploded schematic view of the trim element according to the invention,

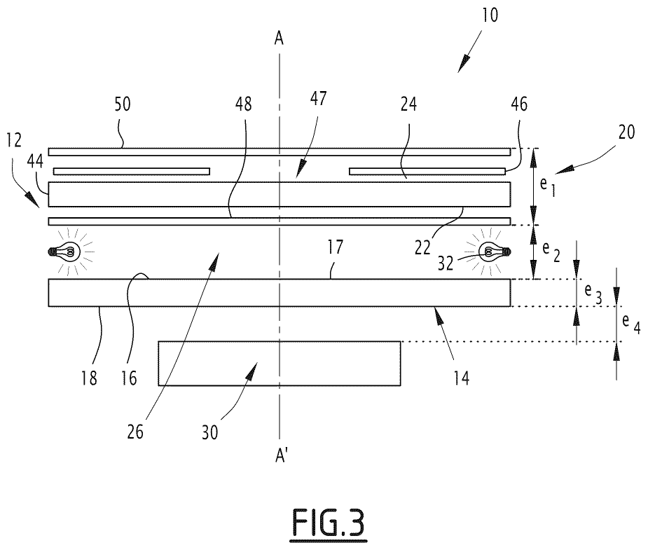

FIG. 3 is a second schematic sectional representation of the trim element according to the invention.

Referring to FIG. 1, a trim element 10 for a vehicle is described, comprising a casing 12 extending in a thickness direction designated A-A′ and a radar 30 located outside the casing 12.

The casing 12 comprises a support element 14 and a decorative element 20 assembled to each other to form the casing 12 by defining an internal volume 26 between them, the internal volume 26 receiving a light source 32.

The support element 14 extends in the thickness direction A-A′ between an internal face 16 facing the inside of the casing and an external face 18, opposite the internal face 16 and intended to be facing the vehicle when the trim element 10 is mounted on the vehicle.

Subsequently, the term “transparent” will be used to describe a material that allows radiation to pass through at least in the thickness direction A-A′. The radiation can be visible light or electromagnetic radiation.

At least part of the internal face 16 of the support element 14 forms a diffusing zone 17, which diffuses at least part of incident visible light emitted by the light source 32 towards the internal face 16 of the support element 14 and to direct this light towards the decorative element 20 in the thickness direction. As shown in FIG. 2, the support element 14 comprises on its internal face 16, an edge 15 comprising, for example, a rib 19 extending in projection from the internal face 16 in the thickness direction A-A′. The rib 19 extends, for example, along the entire edge 15 of the internal face 16 and surrounds all or part of the diffusing zone 17. The rib 19 thus defines an imprint within which the diffusing zone 17 extends.

The support element 14 is, for example, made of white polycarbonate so that its internal face 16 is entirely diffusing. Alternatively, the diffusing zone 17 is made of a material distinct from that of the support element 14, for example, in the form of a layer of reflective material deposited on the internal face 16.

A thickness e3 of the support element 14 is defined as the distance separating the internal face 16 and the external face 18; this thickness e3 is, for example, between 2 and 3 millimeters, for example, approximately equal to 2.3 millimeters.

Alternatively, the diffusing zone 17 covers substantially the entirety of the internal face 16 of the support element 14.

The decorative element 20 also extends in the thickness direction A-A′, between an internal face 22 facing the internal face 16 of the support element 14 and an external face 24 opposite the internal face 22. The external face 24 of the decorative element 20 is thus intended to be facing the outside of the vehicle and to be visible from the outside of the vehicle. The decorative element 20 comprises a body 44 between its internal face 22 and its external face 24. According to one embodiment, the external face 24 of the decorative element 20 forms part of the external surface of the vehicle body.

Advantageously, the body 44 of the decorative element 20 is made of a diffusing material.

The term “diffusing material” should be understood to mean a material that, when it receives visible radiation, diffuses this radiation in the thickness of the decorative element.

In a particular case, the body 44 is made of polymer and shaped by plastic injection. The polymer is, for example, polycarbonate or polymethyl methacrylate acrylic.

FIG. 2 illustrates a decorative element 20 comprising an edge 21. The edge 21 comprises a rib 29 that extends in projection from the internal face 22 in the thickness direction A-A′.

According to one embodiment, the decorative element 20 comprises, on its external face 24, an opaque mask 46, i.e., preventing light from passing through the external face 24. The mask 46 and the body 44 define at least one pattern 47, as visible in FIG. 3. For example, the pattern 47 forms a logo or an alphanumeric character. At least part of the pattern 47 allows light to pass through to form a backlit pattern 47. More particularly, the area of the body 44 not covered by the mask 46 allows light to pass through and thus forms a backlit area whose shape is defined by the mask extending around all or part of the backlit area.

Alternatively, the mask 46 is located on the internal face 22 of the decorative element 20.

According to one embodiment, the decorative element 20 further comprises a protective varnish 48 against condensation. The condensation of water present in the air leads to the appearance of droplets on the internal face of the diffusing body 44. These droplets disturb the optical path and degrade the appearance of the backlit pattern 47. Such a varnish 48 protects against fogging, for example, by preventing water droplets from adhering to the internal face 22.

According to another embodiment of the invention, the decorative element 20 comprises, on its external face 24, a finishing varnish 50. The finishing varnish 50 allows visible light to pass from the internal face 22 to the external face 24. The finishing varnish 50 improves the appearance of the decorative element 20 by giving its external face 24 a shiny appearance. The finishing varnish 50 also improves the flatness of the external face 24, particularly when a mask 46 is located on the body 44 on the side of the external face 24.

The thickness e1 of the decorative element 20 is, for example, between 2 and 3 millimeters, for example, approximately equal to 2.4 millimeters.

Referring to FIG. 1, the casing 12 is closed by a junction 25 between the support element 14 and the decorative element 20. The junction 25 is formed, on the side of the support element 14, by the rib 19 of the edge 15 and on the side of the decorative element, by the rib 29 of the edge 21.

According to a certain embodiment, the junction 25 is hermetic, the casing 12 being thus sealed. This feature enables protection of the various elements contained in the casing 12, notably from dust or external humidity, and contributes to the proper functioning of the trim element 10 over time. The sealing of the junction 25 can notably be ensured by including a seal in the edge 15 of the support element 14 and/or in the edge 21 of the decorative element 20. Alternatively, the sealing of the junction 25 is ensured by an adhesive ensuring the connection between the edge 15 of the support element 14 and the edge 21 of the decorative element 20.

The radar 30 is positioned outside the casing 12, as shown in FIG. 2, on the side of the external face 18 of the support element 14, at a distance e4 from the external face 18 in the thickness direction A-A′. The distance e4 is, for example, between 1.6 and 10 millimeters, for example, approximately equal to 2 millimeters. The radar 30 emits electromagnetic radiation in the thickness direction A-A′. The radar 30 is more particularly oriented so that the emission zone of the electromagnetic radiation traverses the casing 12 to form a detection zone extending outside the casing 12 on the side of the external face 24 of the decorative element 20. To this end, the support element 14 and the decorative element 20 are transparent to the electromagnetic radiation of the radar 30.

The radiation emitted by the radar defines an emission zone, presenting, for example, the shape of an emission cone, traversing the casing 12. The emission zone extends opposite the radar 30 in the thickness direction A-A′ and traverses the support element 14, the internal volume 26, and the decorative element 20 of the casing. Preferably, the emission zone of the electromagnetic radiation of the radar 30 traverses at least part of the pattern 47.

The radar 30 advantageously has a connection 33, preferably removable, allowing the radar 30 to be fixed to a part of the vehicle, for example, an element connected to the bumper of the vehicle. Thus, the radar 30 can be easily removed from the vehicle, facilitating maintenance operations.

Alternatively, the radar 30 is fixed to the casing 12 via the connection 33, allowing access to the radar 30 by removing the casing 12.

The thickness of the radar 30 taken in the thickness direction A-A′ is preferably between 9 and 10 millimeters, for example, equal to 9.7 millimeters.

The light source 32 emits visible light at least partially towards the diffusing zone 17 of the support element 14, so that at least part of the visible light is reflected by the reflecting zone towards the internal face 22 of the decorative element 20. The diffusing zone 17 thus acts as a surface light source, extending opposite the decorative element 20 in the thickness direction A-A′, when light is incident on it.

The light source 32 comprises at least one light guide 34, intended to diffuse visible light from a light source 36. The light guide 34 of the trim element 10 is comprised in a space extending between the internal face 16 of the support element 14 and the internal face 22 of the decorative element 20, and being located in the internal volume 26 of the casing. The light guide 34 then extends at least partially around the emission zone of the electromagnetic radiation of the radar 30, in a radial plane perpendicular to the thickness direction A-A′.

The light guide 34 is located in the space between the internal face 22 of the decorative element 20 and the internal face 16 of the support element 14; the space is characterized by a thickness e2 in the thickness direction A-A′. The thickness e2 is between 4 and 6 mm, preferably approximately equal to 5 mm. Such a distance prevents condensation inside the casing 12 while ensuring the compactness of the system.

In the embodiment shown in FIG. 3, the light source 32 comprises two light guides 34 extending on either side of the emission zone of the electromagnetic radiation of the radar 30. The two light guides 34 extend in the same radial plane perpendicular to the thickness axis A-A′ and follow the shape of the edge 15 of the support element 14 and/or the edge 21 of the decorative element 20, for example, by being applied against the junction 25. The two light guides 34 each extend between two ends 38. Each end 38 of a light guide 34 is connected to the corresponding end 38 of the other light guide 34, via a connecting element 40.

Advantageously, the connecting element 40 includes a light source 36, the light source 36 being, for example, an LED (light-emitting diode). The connecting element 40 includes, for example, a printed circuit 41 including a plurality of electrical paths allowing the light source 36 to be powered, thanks to an energy source (not shown).

In the embodiment shown in FIG. 3, the or each light guide 34 has a circular section and extends substantially along the junction 25 between the support element 14 and the decorative element 20. The light guide 34 thus formed presents a circular section shape, which allows for homogeneous diffusion of the light intended to be injected into the light guide 34. The light from a light source 36 is located at one end of a light guide 34, the light guide 34 diffuses this light at least partially towards the diffusing zone 17 of the support element 14. Preferably, the light guide is made of a transparent material.

The emission zone of the radar 30 is at least partially included in the space located between the two light guides 34, and is preferably entirely included in the space located between the two light guides 34. In other words, the light guides 34 do not extend and do not intersect the emission zone of the radar 30. The visible light ensuring the backlighting of the pattern 47 does not come directly from the light guides 34 but results from the reflection of visible light from the light guides 34 on the diffusing zone 17.

The trim element 10 according to the invention thus allows a radar 30 to be integrated behind a casing 12, in a compact manner thanks to a small thickness of the casing in the thickness direction A-A′. The use of the support element 14, both as the lower part of the casing 12 and as a visible light reflection element, contributes to reducing the number of layers composing the trim element 10. The advantageous position of the radar 30 behind the casing 12 facilitates easy access to the radar 30 for maintenance purposes without having to disassemble the casing 12.

The use of elongated light guides 34 to produce lighting through a diffusing zone 17 contributes to the compactness of the trim element 10 as well as to a better perceived quality of the backlit pattern 47.

1. A vehicle trim element comprising:
a casing extending in a thickness direction between a support element and a decorative element,
a radar emitting electromagnetic radiation in the thickness direction, said radar being positioned outside the casing on the side of the support element, the electromagnetic radiation traversing said casing from the support element to the decorative element in an emission zone,
a light source extending in the casing between the support element and the decorative element, said light source emitting visible light radiation,
characterized in that the light source extends around at least part of the emission zone and illuminates the decorative element in the thickness direction, at least part of the light radiation being reflected in the casing by the support element so as to direct said part of the radiation in the thickness direction in the emission zone.

2. The vehicle trim element according to claim 1, wherein the support element extends in the thickness direction of the casing, between an external face and an internal face, facing the inside of the casing, the radar extending opposite the external face and emitting electromagnetic radiation traversing the support element from the external face to the internal face, the support element being transparent to the electromagnetic radiation emitted by the radar, at least part of the internal face reflecting visible light so that the light emitted by the light source is reflected by said part of the internal face in the thickness direction towards the decorative element.

3. The vehicle trim element according to claim 1, wherein the decorative element extends in the thickness direction of the casing between an internal face facing the inside of the casing and an external face, the decorative element being transparent to electromagnetic radiation from the internal face to the external face and diffusing visible light.

4. The vehicle trim element according to claim 1, wherein a mask is applied to the internal face or the external face of the decorative element, said mask defining a pattern comprising at least one opaque zone and one zone allowing light to pass through.

5. The vehicle trim element according to claim 4, wherein at least part of the pattern extends opposite the emission zone so as to be traversed by the electromagnetic radiation.

6. The vehicle trim element according to claim 1, wherein the light source comprises at least one light source injecting light into the light guide, the light guide extending between the support element and the decorative element around at least part of the emission zone in a radial plane perpendicular to the thickness direction of the casing.

7. The vehicle trim element according to claim 6, wherein the light source comprises two light guides extending on either side of the emission zone in the radial plane.

8. The vehicle trim element according to claim 7, wherein the two light guides each extend between two ends, each end of a light guide being connected to the corresponding end of the other light guide by a connecting element carrying a light source and extending outside the emission zone.

9. The vehicle trim element according to claim 7, wherein the emission zone is entirely included in the space located between the two light guides in the radial plane.

10. The vehicle trim element according to claim 1, wherein the casing is sealed between the support element and the decorative element.
